(19) United States
(12) Patent Application Publication
(10) Pub. No.: US 2009/0327133 A1
(43) Pub. Date: Dec. 31, 2009

(54) SECURE MECHANISM AND SYSTEM FOR PROCESSING FINANCIAL TRANSACTIONS

(75) Inventors: Eldad Aharoni, Raanana (IL); Alicia Ismach, Netanya (IL)

Correspondence Address: OLIFF & BERRIDGE, PLC, P.O. BOX 320850, ALEXANDRIA, VA, 22320-4850, US

(73) Assignee: SEERGATE LTD., Raanana (IL)

(21) Appl. No.: 12/374,776

(22) PCT Filed: Jul. 18, 2007
(86) PCT No.: PCT/IL2007/000907

§ 371 Date: Jan. 22, 2009

Related U.S. Application Data
(60) Provisional application No. 60/821,961, filed on Aug. 10, 2006.

(51) Int. Cl. G06Q 40/00; G06Q 20/00; G06F 17/30

(52) U.S. Cl. 705/44; 705/39; 707/104.1; 707/200; 707/E17.005; 707/E17.044

(57) ABSTRACT

A system for secure processing payment transactions between merchants and customers, via financial institutions, the system comprising apparatus for generating global transaction identifiers each of which is recognized by the merchants as a transaction ID and by the financial institutions as a fundable entity, and methods useful in conjunction therewith.

### REFERENCE TO CO-PENDING APPLICATIONS

Priority is claimed from U.S. provisional application No. 60/821,961, filed 10 Aug. 2006 by Eldad Aharoni and Alicia Ismach.

### FIELD OF THE INVENTION

The present invention relates generally to electronic commerce systems and more particularly to management of secured electronic transactions.

### BACKGROUND OF THE INVENTION

Conventional Internet sources such as Wikipedia teach that: “A debit card is a plastic card which provides an alternative payment method to cash when making purchases. Physically the card is an ISO 7810 card like a credit card; however, its functionality is more similar to writing a cheque as the funds are withdrawn directly from either the cardholder's bank account (often referred to as a cheque card), or from the remaining balance on a gift card.

Depending on the store or merchant, the customer may swipe or insert his card into the terminal, or he may hand it to the merchant who will do so. The transaction is authorized and processed and the customer verifies the transaction either by entering a PIN or, occasionally, by signing a sales receipt.

In some countries the debit card is multipurpose, acting as the automated teller machine card for withdrawing cash and as a cheque guarantee card. Merchants may also offer “cashback”/“cashout” facilities to customers, where a customer can withdraw cash along with their purchase.

The use of debit cards has become widespread in many countries and has overtaken cheque payments, and in some instances cash transactions, by volume. Like credit cards, debit cards are used widely for telephone and Internet purchases. This may cause inconvenient delays at peak shopping times (e.g. the last shopping day before Christmas), caused when the volume of transactions overloads the bank networks.

There are currently two ways that debit card transactions are processed: online debit (also known as PIN debit) and offline debit (also known as signature debit). In some countries, including the United States and Australia, they are often referred to at point of sale as “debit” and “credit” respectively, even though in either case the user's bank account is debited and no credit is involved.

Online debit cards typically require electronic authorization of every transaction and the debits are reflected in the user's account immediately. The transaction may be additionally secured with the personal identification number (PIN) authentication system and some online cards require such authentication for every transaction, essentially becoming enhanced automatic teller machine (ATM) cards. One difficulty in using online debit cards is the necessity of an electronic authorization device at the point of sale (POS) and sometimes also a separate keypad to enter the PIN, although this is becoming commonplace for all card transactions in many countries. Overall, the online debit card is generally viewed as superior to the offline debit card because of its more secure authentication system and live status, which alleviates problems with processing lag on transactions that may have been forgotten or not authorized by the owner of the card. Banks in some countries, such as Canada and Brazil, only issue online debit cards.

In the United States, most online debit transactions are handled by regional ATM networks, though VISA and MasterCard each own online debit networks (Interlink and Maestro, respectively). Online debit is usually provided as a secondary feature on an offline debit card (Visa Cheque Card or Debit MasterCard); those customers that do not qualify for offline debit cards are often issued ATM cards with online debit capability through the regional ATM, Interlink and/or Maestro networks.

In the United Kingdom, Solo and Visa Electron are examples of online debit cards, which are typically issued by banks to customers whom the bank does not want to be overdrawn under any circumstances, for example under −18 s.

Offline debit cards have the logos of major credit cards (e.g. Visa or MasterCard) or major debit cards (e.g. Maestro in the United Kingdom and other countries, but not the United States) and are used at point of sale like a credit card. This type of debit card may be subject to a daily limit, as well as a maximum limit equal to the amount currently deposited in the current/checking account from which it draws funds. Offline debit cards in the United States and some other countries are not compatible with the PIN system, in which case they can be used with a forged signature, since users are rarely required to present identification. Transactions conducted with offline debit cards usually require 2-3 days to be reflected on users' account balances. This type of debit card is similar to a secured credit card.

In the United States and Australia, offline debit transactions are usually referred to at point of sale as “credit” transactions even though no credit is actually involved. This is because they are processed through the Visa or MasterCard networks in the exact same manner as actual credit card transactions. Since they are handled like any other Visa or MasterCard, U.S. and Australian offline debit cards are also accepted worldwide with virtually all merchants that accept U.S. or Australian credit cards of the corresponding brand, even if they do not accept their own country's debit cards.

In the U.S., Visa calls its debit card Visa Cheque Card; MasterCard calls its debit card Debit MasterCard. The vast majority of U.S. debit cards are Visa Cheque Cards; however, Debit MasterCard has made some inroads in recent years. Discover Card has announced an offline debit card through its regional ATM network Pulse; however, few, if any banks, offer this card. The other major U.S. credit card network, American Express, does not offer debit cards.

Some merchants in the U.S. have recently been allowed to bypass the signature requirement for “credit” sales (including offline debit) if the total sale is under a certain dollar amount. This is based on the assumption that customers want a fast and easy to use point-of-sale process, and low-value transactions are not the activity of a fraudulent user.

In the United Kingdom, Maestro (formerly Switch) and Visa Debit (formerly Delta) are examples of offline debit cards. This is in contrast to the U.S. where Maestro is an online debit brand.

In some countries and with some banks and merchant service organizations (as of this writing), a “credit” or offline debit transaction is without cost to the purchaser beyond the face value of the transaction, while a small fee may be charged for a “debit” or online debit transaction (although it is often absorbed by the retailer). Other differences are that online debit purchasers may opt to withdraw cash in addition to the amount of the debit purchase (if the merchant supports that functionality); also, from the merchant's standpoint, the merchant pays lower fees on online debit transaction as compared to “credit” or offline debit transactions.

The fees charged to merchants on offline debit purchases—and the lack of fees charged to merchants for processing online debit purchases and paper cheques—have prompted some major merchants in the U.S. to file lawsuits against debit-card transaction processors such as Visa and MasterCard. In 2003, Visa and MasterCard agreed to settle the largest of these lawsuits which cost them billions of dollars.

Many consumers prefer “credit” transactions because of the lack of a fee charged to the consumer/purchaser; also, a few debit cards in the U.S. offer rewards for using “credit”. However, since “credit” costs more for merchants, many terminals at PIN-accepting merchant locations now make the “credit” function more difficult to access. For example, if a debit card is swiped at Wal-Mart in the U.S., the user is immediately presented with the PIN screen for online debit; to use offline debit the user must press “cancel” to exit the PIN screen, then press “credit” on the next screen.

ModaSolutions provides an eBillme online system. According to the modasolutions.com website, eBillme “uses the same information that the consumer provides the merchant when placing an order online or by phone” including “billing . . . information”. The website also states that “At no time is the consumer required to provide their credit card number or any other personal financial information.” The ModaSolutions system does not link directly to the consumer's online banking account. “When a consumer receives their eBill, they treat it just like any other bill and securely login to their banking billpay service to complete their payment. Depending on the consumer's bank, consumers may select the payee from a pick list or, they may be required to enter the merchant details (i.e. name and address).” In the eBillme system, “money flows from the customer's bank directly to the merchant's bank account. Payment transfers typically take 2-3 days in the US. The online banking processing network updates the eBillme Gateway. The merchant's backend systems pull payment updates from the eBillme Gateway. Note: Merchants can choose to ship product when payment is confirmed”.

Atmdirect is a client software application in which, according to the atmdirect.com website, “PIN-debit transactions are fully authenticated, real-time cash transactions. PIN-debit payments require a Personal Identification Number or PIN with every transaction . . . . Atmdirect's Internet PIN-debit transactions process over the world's bank and EFT networks like conventional transactions and do not require any changes to bank or network infrastructure and processes. This allows rapid and low cost adoption worldwide . . . (T)he consumer's PIN is never in the clear, never available on the merchant site or in the consumer's computer . . . when paying with PIN-debit, the consumer simply enters his PIN using their mouse on a graphical PIN-pad on their screen. The PIN is authenticated directly with the consumer's bank through [a] secure data center by routing the transaction to the appropriate EFT network without passing the transaction through the merchant's system. The PIN is never in the clear and cannot be logged or hacked. This service is a software based solution that the customer simply downloads when prompted by the merchant or a trusted partner.”

The prior art is known to include the following:

| | |
|---|---|
| U.S. Pat. No. | 7,069,249 |
| Stolfo, et al. | Jun. 27, 2006 |

This patent document describes electronic purchase of goods over a communications network including physical delivery while securing private and personal information of the purchasing party. E-commerce, which may include delivery of goods ordered or purchased over a network (e.g., the Internet) to a purchaser/user, and/or arranging for electronic payment of the goods, is accomplished while securing private and personal information of purchasers/users. Proxy software is provided for user computers, one or more proxy computers, or both, for users to communicate with vendors anonymously over the network, provide for delivery of ordered goods and provide for electronic payment, while securing the user's private information.

| | |
|---|---|
| United States Patent Application | 20040249766 |
| Kind Code | A1 |
| Ganesan, Ravi et al. | Dec. 9, 2004 |

This patent document describes, e.g. at paragraphs 0021-0024 and in FIGS. 1 and 8, a device for conducting secure transactions over a network. A method for conducting cashless transactions includes receiving, at a first network device associated with a seller, information identifying a product intended to be purchased at a purchase price by a purchaser. The purchase price is to be paid through a transfer to the seller of funds deposited in or credited to an account of the purchaser. The identity of the account having the funds is and remains unknown to the seller. The authorization of the purchaser to pay the purchase price for the identified product through the transfer to the seller of the funds in the account is transmitted to a second network device associated with the financial institute at which the account is maintained. A determination is made as to whether or not the funds are sufficient with respect to the purchase price. If so, the authorization of the financial institute for the seller to proceed with delivery of the identified product is transmitted from the second network device to the first network device.

| | |
|---|---|
| United States Patent Application | 20050033659 |
| Kind Code | A1 |
| Zucker, Jeffrey Mark; et al. | Feb. 10, 2005 |

This patent document describes a third party privacy system. A system and method of providing privacy through anonymity is described. As one aspect of the invention, a person registers at a privacy server and is given a pseudo identity that can be used to browse, register, purchase, pay for, and take delivery of products and services. Transactions are completed with the privacy server on a need-to-know basis. A seller communicates with the privacy server but only sees a demand, not the identity of the buyer. The financial institution communicates with the privacy server and sees the payment, not the merchandise. The freight company communicates with the privacy server and sees the package, not its contents. The privacy server operates in a manner that assures privacy and anonymity for the buyer and, if necessary, both the seller as well.

| | |
|---|---|
| U.S. Pat. No. | 7,003,501 |
| Ostroff | Feb. 21, 2006 |

This patent document describes a method for preventing fraudulent use of credit cards and credit card information, and for preventing unauthorized access to restricted physical and virtual sites including a method and a system for enabling secure authentication of a user in a computerized card access transaction. A card, identified by an identification number is issued to the user, containing software for generating a surrogate number referred to as a Cybercoupon for use in place of the regular card number. Online intrusion is avoided and the system is rendered portable for use on any computer equipped with a compatible operating system, by avoiding storage of any part of the system on the user's computer, placing the entire system instead on the card itself. The card contains advertising which appears on the user's computer screen. The card is protected by a password. If an incorrect password is entered more than a preset number of times, an “alert” Cybercoupon is generated containing a code advising the card issuer that an irregular attempt has been made to access the card.

| | |
|---|---|
| U.S. Pat. No. | 6,901,387 |
| Wells et al. | May 31, 2005 |

This patent document describes an electronic purchasing method and apparatus for performing the same. A computer-assisted method includes hardware, software and telecommunications components that cooperatively achieve the technical effect of an improved electronic purchasing transaction system. In various embodiments of the invention, at least one master account is established for a client. A pool of limited use account identifiers or secondary account identifiers, that are separate and distinct from the master account, is associated with the master account by a purchasing system or account management system. Each of the limited use account identifiers may be used by the client to purchase items from merchants.

| | |
|---|---|
| U.S. Pat. No. | 6,748,367 |
| Lee | Jun. 8, 2004 |

This patent document describes a method and system for effecting financial transactions over a public network without submission of sensitive information. The system comprises a common controller in data communication with at least one public network. The common controller includes a processor for generating digital tokens wherein each digital token represents a particular monetary value and contains a particular digital signature and alterable digital token status data indicating ownership of the digital token. The system includes a plurality of user data communication interfaces in data communication with the public network. The processor of the common controller includes data bases for storing user account information such as user identification and PIN, and account values and for authenticating the user identification and PIN to determine whether access to the common controller is permitted. The common controller generates an application level secure communication channel through which all data communication is to be effected and transmits data representing a template of an automated teller machine to the user data communication interface of a first user whose identification PIN was previously authenticated. Financial transactions between the first user and a second user are initiated by using the automated teller machine to transmit a request to the common controller to effect a transfer of a monetary sum to a destination account. The common controller generates a temporary account identified by an account number for temporarily storing the transferred monetary sum and also generates multiple digital tokens having a value equal to the monetary sum in the temporary account and data defining a unique digital signature and a digital token status. The temporary account number is encrypted.

U.S. Pat. No. 7,069,249 describes electronic purchase of goods over a communications network including physical delivery while securing private and personal information of the purchasing party. This, together with its prior art references, and in particular Published Application No. 249766 and eBillMe, a related service provided by ModaSolutions, is believed at time of filing to be the closest prior art on record.

U.S. Pat. No. 7,003,480 pertains to GUMP, a grand unified meta-protocol for simple standards-based electronic commerce transactions.

Other prior art systems are described in U.S. Pat. Nos. 6,834,271 (Hodgson) and 6,675,153, and in Published US Patent Application Nos. 20060242084 (Moses), 2007/0073629 (e.g. at paragraphs 0007-0013 and FIG. 1, which discuss transaction ID's, 2001/0034724 (e.g. in FIGS. 1-3), 2002/0133468, e.g. at paragraphs 0013 and 0014 and FIGS. 3 and 4, 2003/0037012 e.g. at paragraph 0017, 2007/0078787, 2003/0018567 e.g. re utilization of unique payment numbers, and 2002/008746.

The disclosures of all publications and patent documents mentioned in the specification, and of the publications and patent documents cited therein directly or indirectly, are hereby incorporated by reference.

### SUMMARY OF THE INVENTION

The present invention seeks to provide an improved and highly secure system for interaction between financial institutions, merchants and customers.

One embodiment of the present invention proposes generation of an identifier code that uniquely recognizes a specific business transaction of a selling party (“Merchant”) and at the same time is recognized by participating Financial Institutions as a fundable entity, similar to a bank account number or credit/debit card number.

According to certain embodiments, a system facilitating secure, private Internet purchases by bridging between merchants and financial institutions is provided. Complete separation may be provided between the environment where the purchase is taking place (merchant) and the environment where the payment is completed (financial institution), ensuring that financial information remains within the financial institution boundaries and that purchase information remains within the merchant boundaries. A unique code is provided to link between systems and serve as an identifier that is recognized by the selling party (“Merchant”) as a transaction number and by standard Financial Systems as a fundable entity, such as a bank account number or credit/debit card number. The process may take place over known and trusted infrastructures, takes place in real time, and takes advantage of an A2A mechanism that allows transferring of funds between payment cards.

Payment transactions are typically processed by receiving a payment instruction from the end-user and transmitting the payment instruction to a financial institution for clearance. Certain payment methods such as credit cards, electronic checks and non-PIN debit cards are high risk transactions in non-present purchasing environments, requiring costly security systems and yet exposing the end-user to identity fraud. Sensitive information can be entered into a number of systems' databases of the various involved parties, and may include customer's financial information, sometimes replicated to many parties (merchant, payment processor, gateway, etc.). Such information, although sometimes highly sensitive, is required by the participating entities involved for closing a transaction.

End-users interested in physically paying for a non-present purchase are able to do so by wiring funds or sending a bank draft/money order to the Merchant, manual methods that consume time from when payment received is correctly linked to the transaction number by the Merchant or intermediary payment processor, and the product or service is released. The period of time between payment and release is inconvenient from the end-user's point of view. The necessity to recognize the correct transaction number for the payment received is time-consuming and increases processing costs for the merchant.

Other offline payment methods require integration with physical locations and the adaptation of payment locations to accept payments in a specific manner, meaning that the customer, at time of payment, needs to give the merchant identification or payment processor identification, allowing the location to link the transaction number provided to the relevant processing party, and then proceed to pay for it, otherwise the transaction is not recognized.

Thus there is a need for a secure and preferably easy to adopt embodiment which allows full separation between the merchant system, dealing with purchasing information, and the financial system, dealing with financial information. No sensitive information is exchanged between merchants, payment processors and financial systems. The relevant information is stored in the databases of the most relevant party. Sensitive information never crosses the boundaries of its owner's system. This means that bank account and/or credit/debit/prepaid card information remains within its proprietor, a financial institution, while purchasing related information such as type of product, price and other deal terms remain within its proprietor, a merchant.

Thus there is a further need to allow the customer to keep his buying habits private, meaning that his financial information is not disclosed to the merchant, while his purchasing information is not disclosed to the financial institution.

Several methods and systems for improving privacy and security in electronic payments exist in the prior art. However, existing methods and systems may require disclosure of financial information to a third party that encrypts or transforms such sensitive information into a new code for utilizing it as payment method. These methods are susceptible to fraud, and put a customer's information at risk, whether the encryption methods are decrypted or the databases behind the systems are illegally accessed. Furthermore, these systems usually add complexity to the process and method, increase costs and in many cases replicate some of the data.

Based on the existing non-present purchases problems, including fraud, identity theft and costly offline payments, there is a need to provide an easy to adopt, secure, straightforward, payment identifier that, once paid at a trusted financial location, automatically settles a purchasing transaction.

In particular there is a need to provide an offline payment method for non-present purchases such as Internet commerce, catalog mail orders and TV shopping, among others, that works over existing widespread financial networks in an easy to use, cost effective manner, providing the same level of security as any other banking transaction, but without the complexity of integrating with financial institutions systems. Such a method should enable use for any type of transaction, even by two entities that are located on two different continents.

From the customer's point of view, it is desirable to offer an offline payment method that is electronically settled at the time of payment and/or does not require the completion of forms and/or provides the simplicity of a known banking transaction.

In order for the financial institute to process/complete the transaction, the financial institute typically receives the following information/package: user credentials, global transaction identifier and transaction amount. As for user credentials, the financial institute may decide which information it requires from the customer; this could be user name and password, or any other means that the user has to provide in order to authenticate himself. The global transaction identifier typically comprises a code that is linked to a specific merchant transaction and could be referred to as a debit card in debt for the purchase price (transaction amount).

An advantage of certain embodiments of the present invention is an easy, straightforward user experience, allowing the customer to complete the purchasing transaction rapidly and without diversion of customer attention therefrom. To achieve this, once the customer authenticates himself to the financial institute, he/she is presented, on-line, with a payment form with all the relevant data, e.g. global transaction identifier and amount, for him to acknowledge e.g. by a single click and he does not have to perform any other operations to reach this form right after authentication. Until the financial institute validates the user with the credentials he provides, the global transaction identifier and amount may be stored as session parameters or hidden parameters in the login form.

According to certain embodiments, a payment system is provided which is characterized in that transaction information is transferred only between a purchaser and a merchant whereas financial information is transferred only between the purchaser and a financial institution.

There is thus provided, in accordance with a preferred embodiment of the present invention, a system for interaction between a first plurality of financial institutions, a second plurality of merchants and customers of the first plurality of financial institutions and of the second plurality of merchants, each financial institution (FI) maintaining a population of accounts serving a corresponding population of customers, each financial institution being capable of performing debiting operations on individual accounts from among the corresponding population of accounts, the system comprising a global transaction ID database for storing a multiplicity of global transaction identifiers each representing a unique individual transaction between an individual one of the second plurality of merchants each entering into transactions with their own customers and an individual one of the individual merchant's customers who is also a customer of an individual one of the first plurality of financial institutions, wherein an amount of payment is defined for each individual global transaction identifier; and for each FI from among the first plurality of financial institutions, an FI processor which is operative to receive an on-the-fly indication of an individual one of the FI's accounts corresponding to an individual one of the FI's customers, a global transaction identifier, and a corresponding amount of payment to be debited from that individual account upon customer confirmation, to transmit to the individual one of the financial institution's customers, on-the-fly, a request to confirm debiting of the corresponding amount of payment from the customer's account for the transaction corresponding to the global transaction identifier, to accept from the customer a responsive confirmation; and to debit the customer's account accordingly.

Further in accordance with a preferred embodiment of the present invention, the system also comprises, for each of the second plurality of merchants, a merchant's internal transaction ID database for storing a population of internal transaction identifiers each representing, to a corresponding individual merchant, an individual transaction between the individual merchant and an individual one of the individual merchant's customers, at least one internal transaction identifier being associated with a global transaction identifier.

Still further in accordance with a preferred embodiment of the present invention, the transaction comprises a service transaction and/or a goods transaction.

Further in accordance with a preferred embodiment of the present invention, the individual one of the second plurality of merchants receives on-the-fly confirmation of the debiting of the customer's account.

Additionally in accordance with a preferred embodiment of the present invention, a copy of the global transaction ID database is maintained in each financial institution.

Further in accordance with a preferred embodiment of the present invention, a copy of the global transaction ID database is maintained on the premises of each merchant.

Additionally in accordance with a preferred embodiment of the present invention, the system also comprises a central transaction processor operative to update the merchant's internal transaction ID database if informed by the FI processor that the transaction corresponding to the global transaction identifier has been redeemed.

Further in accordance with a preferred embodiment of the present invention, a customer interface of at least an individual one of the first plurality of financial institutions is operative to provide to the individual financial institution's FI processor an on-the-fly indication of at least some of the following information: an individual one of the FI's accounts, a global transaction identifier and a corresponding amount of payment to be debited from that account.

Still further in accordance with a preferred embodiment of the present invention, the system also comprises, for each merchant, a merchant processor operative, responsive to an update to the merchant's internal transaction ID database indicating that a transaction has been redeemed, to carry out the transaction.

Further in accordance with a preferred embodiment of the present invention, the central transaction processor is operative to provide to the FI processor an on-the-fly indication of at least some of the following information: an individual one of the FI's accounts, a global transaction identifier and a corresponding amount of payment to be debited from that account upon customer confirmation of the transaction.

Still further in accordance with a preferred embodiment of the present invention, the FI processor is operative to update the merchant's internal transaction ID database by informing the central interaction processor that the transaction corresponding to the global transaction identifier has been redeemed.

Further in accordance with a preferred embodiment of the present invention, the individual one of the second plurality of merchants provides at least one of goods and services on-line, responsive to the on-the-fly confirmation.

Still further in accordance with a preferred embodiment of the present invention, the system also comprises a central financial institution database storing identifying information pertaining to each of the first plurality of financial institutions.

Additionally in accordance with a preferred embodiment of the present invention, the system also comprises a central merchant database storing identifying information pertaining to each of the second plurality of merchants.

Further in accordance with a preferred embodiment of the present invention, the system also comprises an apparatus for bringing a customer into an online presence of an individual one of the first plurality of financial institutions, within which the request to confirm debiting is transmitted to the customer, on-the-fly.

Still further in accordance with a preferred embodiment of the present invention, the amount credited to the global transaction identifier for each transaction is then transferred to an account belonging to the merchant corresponding to the transaction, off-line.

Also provided, in accordance with a preferred embodiment of the present invention, is a method for interaction, via a computer network, between a first plurality of financial institutions, a second plurality of merchants and customers of the first plurality of financial institutions and the second plurality of merchants, all interconnected by a computer network, each financial institution (FI) maintaining a population of accounts serving a corresponding population of customers and being capable of performing debiting operations on individual accounts from among the population of accounts, the method comprising maintaining a global transaction ID database including storing a multiplicity of global transaction identifiers each representing a unique individual transaction between an individual one of the second plurality of merchants each entering into transactions with their own customers and an individual one of the merchant's customers who is also a customer of an individual one of the first plurality of financial institutions, wherein an amount of payment is defined for each individual global transaction identifier; and for each transaction, bringing the transaction's customer into an online presence of a financial institution of which the transaction's customer is a customer.

Further in accordance with a preferred embodiment of the present invention, the method also comprises A to A (account to account) debiting of a debit card associated with the customer's account.

Still further in accordance with a preferred embodiment of the present invention, the merchant processor is operative to provide to the FI processor an on-the-fly indication of at least some of the following information: a global transaction identifier and a corresponding amount of payment to be debited from that account upon customer confirmation of the transaction.

Further in accordance with a preferred embodiment of the present invention, the FI processor is also operative to update the merchant's internal transaction ID database to indicate that the transaction corresponding to the global transaction identifier has been redeemed.

Still further in accordance with a preferred embodiment of the present invention, at least one internal transaction identifier equals the global transaction identifier associated therewith.

Further in accordance with a preferred embodiment of the present invention, at least one individual merchant from among the second plurality of merchants includes a customer solicitation processor operative to obtain a set of global transaction identifiers from the FI processor and to transmit the set of global transaction identifiers, to a set of at least potential customers, respectively, thereby to enable a potential customer, if he/she is a customer of at least one of the first plurality of financial institutions, to initiate an on-line transaction with the individual merchant via the FI processor without previously initiating contact with the merchant.

Also provided, in accordance with another preferred embodiment of the present invention, is a system for processing payment transactions between merchants and customers, via financial institutions, the system comprising an apparatus for generating global transaction identifiers, each of which is recognized by the merchants as a transaction ID, and by the financial institutions as a fundable entity.

Further provided, in accordance with another preferred embodiment of the present invention, is a system for interaction between a first plurality of financial institutions, a second plurality of merchants and customers of the first plurality of financial institutions and the second plurality of merchants, each financial institution (FI) maintaining a population of accounts serving a corresponding population of customers, each financial institution being capable of performing debiting operations on individual accounts from among the population of accounts, the system comprising a global transaction ID database for storing a multiplicity of global transaction identifiers each representing a unique individual transaction between an individual one of the second plurality of merchants each entering into transactions with their own customers and an individual one of the merchant's customers who is also a customer of an individual one of the first plurality of financial institutions, wherein an amount of payment is defined for each individual global transaction identifier, and wherein each individual global transaction identifier is identified by financial institutions as a fundable entity; and for each of the first plurality of financial institutions, an FI processor operative to receive an on-the-fly indication of an individual one of the FI's accounts corresponding to an individual one of the FI's customers, a global transaction identifier, and a corresponding amount of payment to be debited from that account upon customer confirmation, to debit the customer's account accordingly; and to directly credit the global transaction identifier in its capacity as a fundable entity.

Further in accordance with a preferred embodiment of the present invention, the system also comprises at least one financial institution storing, for each individual debiting operation, documentation justifying the individual debiting operation.

Still further in accordance with a preferred embodiment of the present invention, each individual global transaction identifier is recognized by the financial institutions as a fundable entity.

Further in accordance with a preferred embodiment of the present invention, the system also comprises apparatus for pushing a customer through an online presence of an individual one of the first plurality of financial institutions, including presenting the customer with a payment form containing data for the transaction corresponding to the global transaction identifier.

Further in accordance with a preferred embodiment of the present invention, the method also comprises, for each individual transaction, pushing the transaction's customer through the online presence of the customer's financial institution including presenting the customer with a payment form, within the online presence, containing data for the individual transaction.

Still further in accordance with a preferred embodiment of the present invention, the on-line presence comprises a website.

Debiting of a customer's account, on-line, may comprise a process of A to A (account to account) debiting of a debit card associated with the customer's account.

The term “Debit card” as used herein is intended to include a Card containing information identifying a source of payment, such as a bank account, belonging to the bearer of the card, whose information is readable by a terminal. To effect a transaction in which his bank account or other source is debited, the card bearer submits his card to a third party device such as a merchant's terminal or ATM and confirms the transaction e.g. by signing or by supplying a PIN. Unlike credit cards, which debit the card bearer's account many days after the transaction and allow the card bearer's account to overdraw, debit cards debit the card bearer's account within seconds or minutes and do not allow the card bearer's account to overdraw.

Preferably, an FI processor trigger generator is provided which is operative to provide to the FI processor a stream of on-the-fly transaction indications, each transaction indication comprising a capability to determine an identity of an individual one of the FI's accounts associated with a global transaction identifier and with a corresponding amount of payment to be debited from that account upon customer confirmation.

Each transaction indication may comprise a capability to determine an identity of an individual one of the FI's accounts temporally associated with a global transaction identifier and with a corresponding amount of payment to be debited from that account upon customer confirmation. A transaction indication may, alternatively, comprise association information associating a specific identity of an individual one of the FI's accounts, a specific global transaction identifier and a specific amount of payment to be debited from that account upon customer confirmation.

Any suitable processor, display and input means may be used to process, display and accept information as described herein, such as but not limited to a conventional personal computer processor; display screen and/or printer; and keyboard/mouse.

Workstations practicing the invention shown and described herein may communicate via any conventional wired or wireless digital communication means, optionally via a communication network such as the Internet.

### BRIEF DESCRIPTION OF THE DRAWINGS

Preferred embodiments of the present invention are illustrated in the following drawings:

FIG. 1 is a simplified pictorial illustration of a transaction payment system constructed and operative in accordance with a preferred embodiment of the present invention;

FIG. 2 is a simplified diagram of a method of operation of the system of FIG. 1 according to a preferred embodiment of the present invention;

FIG. 3 is a simplified block diagram illustration of the central transaction manager of FIG. 1 constructed and operative in accordance with a preferred embodiment of the present invention;

FIG. 4 is a transaction management system constructed and operative in accordance with a preferred embodiment of the present invention which operates on-line or in real time;

FIG. 5A is a simplified block diagram illustration of one possible implementation of the system of FIG. 4 in which identical Roman numerals are used to indicate operations which may occur generally simultaneously;

FIG. 5B is a simplified diagram of one possible implementation of the internal transaction database of FIG. 5A;

FIG. 6 is a table illustrating one possible implementation of the global transaction ID database of FIG. 5A;

FIG. 7 is a simplified flowchart illustration of a method for Sale and Payment on-line over the Internet using a global transaction ID, the method being constructed and operative in accordance with a preferred embodiment of the present invention;

FIG. 8 is a simplified flowchart illustration of a method for Sale over the Internet and Payment offline using a global transaction ID, the method being constructed and operative in accordance with a preferred embodiment of the present invention;

FIG. 9 is a simplified flowchart illustration of a method for Sale over the Internet and Payment, using a global transaction ID, by Mobile phone, the method being constructed and operative in accordance with a preferred embodiment of the present invention;

FIG. 10 is a simplified flowchart illustration of a method for Sale over MOTO (mail order/telephone order) and Payment, using a global transaction ID, by Internet, the method being constructed and operative in accordance with a preferred embodiment of the present invention;

FIG. 11 is a simplified flowchart illustration of a method for using a global transaction ID for Sale over phone and Mobile Phone, the method being constructed and operative in accordance with a preferred embodiment of the present invention;

FIG. 12 is a simplified flowchart illustration of a method for management of transactions occurring via Billing Companies, using a global transaction ID, the method being constructed and operative in accordance with a preferred embodiment of the present invention; and

FIG. 13 is a simplified flowchart illustration of a method for interaction, via a computer network, between a first plurality of financial institutions, a second plurality of merchants and customers of the first plurality of financial institutions and the second plurality of merchants, all interconnected by the computer network, the method being constructed and operative in accordance with a preferred embodiment of the present invention.

### DETAILED DESCRIPTION OF PREFERRED EMBODIMENTS

One embodiment of the system of the present invention enables the payment of a non-present transaction by funding a global transaction identifier, also termed herein a “@BIN” or “global transaction ID”, recognized by standard financial systems such as banks, ATM networks, credit companies, and self-service payment stations, among others, as a financial identifier such as a bank account number and/or credit/debit/prepaid card number and/or any other financial identifier.

BIN typically resembles any financial identifier recognized by financial systems, such as bank accounts, credit/debit/prepaid cards, etc., with the difference that it holds a debt in the amount of the transaction for which it was generated. The global transaction ID's expiration date may be the first of the following to occur: the date provided by the Merchant and/or the end-user's funding date. For example it may be implemented as a Debt Card that holds a Global Transaction ID, debt amount and expiration date that is related to a commercial transaction that was generated between a customer and merchant. Once the customer funds the Debt Card that was linked to the transaction, the Debt Card may expire and the customer receives the goods and/or service purchased. It is appreciated that the Debt Card is typically useless for anyone else except for the customer in the context of its relationship with the system of the present invention.

Under given circumstances, a customer could act as a merchant and a merchant could take on the role of a customer.

One embodiment of the system of the present invention receives transaction information typically from a merchant typically including some or all of the information detailed in the following Table I:

| Parameter Name | Description |
|---|---|
| Transaction ID | Merchant transaction identification code |
| Transaction type | Merchant transaction classification |
| Amount | Transaction amount to be paid |
| Currency | Currency of the amount to be paid |
| Expiration Date | The last date on which the transaction can |
| | be paid |
| Customer info | Customer name and/or e-mail and/or |
| | address and/or phone and/or fax # |
| Product Description | Description of products and/or services |
| | ordered |
| Comments/other | Other information provided by the merchant |
| | in any format |

This information may be transmitted over any communications network. Then the system of the present invention typically generates or retrieves from an existing database or from an external source like a credit card corporation, an ATM network or other financial institution, a Global Transaction ID that is linked to the merchant transaction and sent to the merchant. Additionally, a Global Transaction ID may be generated using a suitable mathematical formula and/or one or more additional reference numbers such as the transaction number, the amount and/or the termination date, among others. Other information may optionally be sent to the merchant together with the Global Transaction ID.

Optionally, a merchant may employ a bulk amount of Global Transaction IDs according to a list of transactions provided to the System shown and described herein. For example a utility biller could incorporate the relevant Global Transaction ID in a customer's bill for services provided to the customer on a recurring or temporary basis, e.g. as electricity or phone bills.

Although a Global Transaction ID may be a onetime payment mechanism, for recurring or multiple payments, Global Transaction ID may be utilized multiple times, settling a payment with the merchant each time the Global Transaction ID is funded accordingly.

The merchant may send the received Global Transaction ID to the customer by electronic, voice or physical means together with or without the amount to be paid. The merchant may, according to one embodiment of the system of the present invention, require Global Transaction ID to be sent directly to the customer by electronic, voice, mobile or physical means.

The customer typically receives a Global Transaction ID and funds it at a financial institution, in person or electronically or by phone, such as but not limited to a banking institution or ATM network, with any available funding method such as but not limited to cash, check, wire transfer, credit card, debit card, prepaid card, and a stored value account.

The financial institution receiving a funding instruction to a Global Transaction ID, notifies the Global Transaction ID issuer, which may comprise a central transaction manager in the system of the present invention or may comprise an

external system that generated the Global Transaction ID, about the amount of the funding transaction, and this funding confirmation may reach a central transaction manager in the system of the present invention directly or through a third party. In case the funding instruction is not processed successfully for any reason, the central transaction manager may or may not receive information about this event.

A central transaction manager in the system of the present invention typically receives a funding transaction to a Global Transaction ID and the amount funded from a financial institution of any other third party. After verifying the Global Transaction ID against the related merchant transaction information available at the central transaction manager, and confirming the validity and amount funding the transaction, the central transaction manager typically transmits a confirmation message to the merchant informing that the transaction has been paid and therefore the goods and/or services can be delivered.

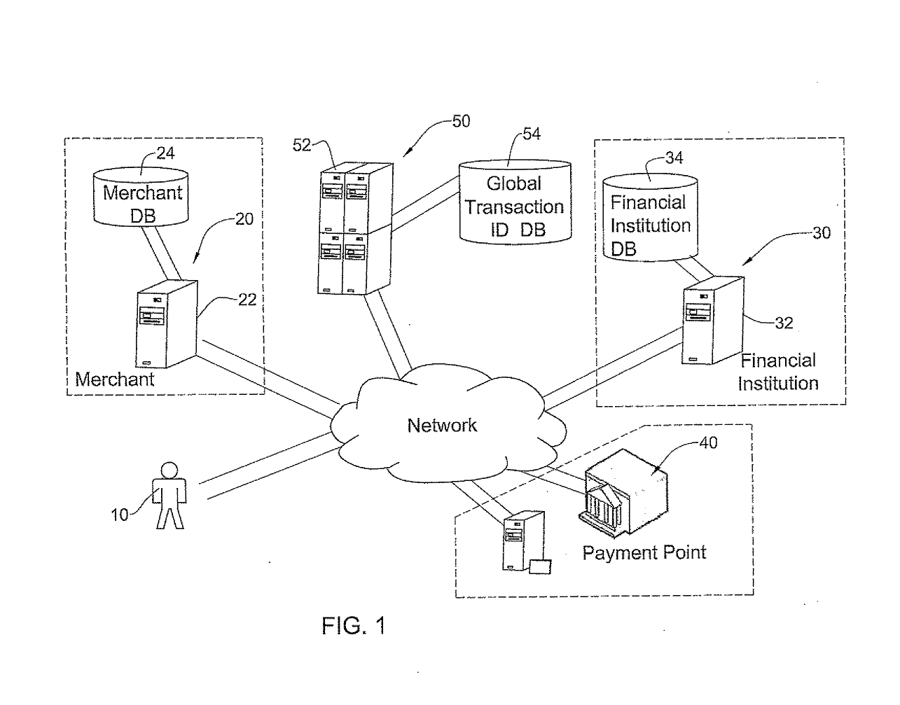

Reference is now made specifically to FIG. 1 which is a simplified pictorial illustration of a transaction payment system constructed and operative in accordance with an embodiment of the present invention. Data communication among the components shown and described herein can be achieved through any suitable electronic method such as but not limited to SMS, MMS, e-mail, computer-to-computer data transfer, or telephone.

A Customer 10 may initiate a transaction in a number of possible ways, such as but not limited to electronically, over the phone, by mail, in person, wirelessly, and by subscribing to a service and being charged afterwards either recurrently or according to use.

A Merchant 20, typically comprising a processor 22 and a database 24, typically receives transaction requests from customers 10, or initiates its own transaction requests (for example for mailing lists promotions). It maintains, e.g. in database 24, customer information related to the transactions and its processor 22 typically manages the transactions according to its own management system. The merchant 20 typically provides a transaction ID when demanding a Global Transaction ID from the system of the present invention.

A Financial Institution 30, typically comprising a processor 32 and a database 34, typically provides a system and network to manage financial transactions, operating

according to strict regulations and standards. Bank accounts and payment cards, among others, are financial identifiers recognized by financial institutions as mechanisms that can hold value and can be funded in many different ways, such as but not limited to cash deposits, card-to-card transfers, and wire transfers.

A Payment Point 40 typically comprises a location where a Global Transaction ID can be funded, such as but not limited to a self-service payment kiosk, an ATM, a bank branch, a phone service, and an online banking functionality.

A central transaction manager 50, which may for example comprise a system having a central processor 52 and a database 54, interfaces between the parties by linking a financial identifier, also termed herein a “global transaction identifier” or “@BIN” to a merchant transaction allowing the customer to pay for a transaction, using the identifier, at the payment point and notifying the merchant about the payment.

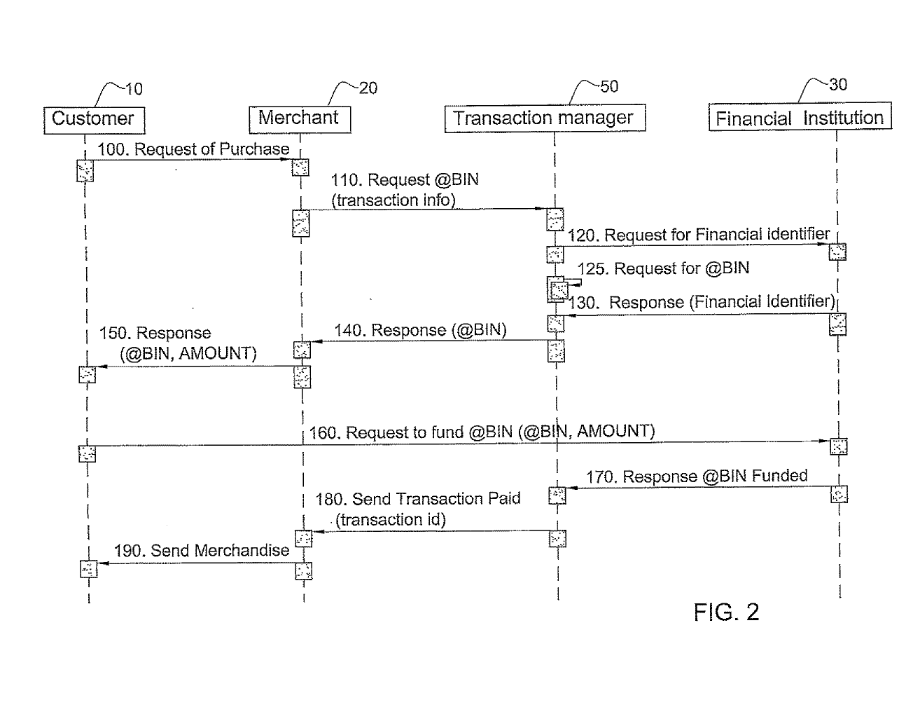

FIG. 2 is a simplified diagram of a method of operation of the system of FIG. 1 according to an embodiment of the present invention. The method of FIG. 2 typically comprises some or all of the following steps:

Step 100: Request of Purchase. A customer 10 reaches the checkout stage at a remote merchant (Internet shop, catalog mail order, TV shopping, etc.) for purchasing a product and/or service, as is conventional.

Step 110: Request Global Transaction ID: The merchant 20 requests, from central transaction manager 50, a financial identifier. The merchant 20 provides the central transaction manager 50 with transaction information e.g. some or all of the information detailed in Table I above.

Step 120: Request Financial Identifier. In the event that the Financial Identifier utilized as Global Transaction ID is provided by an external financial institution, the central transaction manager 50 requests the identifier. In this request, preferably, no merchant and/or customer information is disclosed, including but not limited to type of purchase and merchant name.

Step 125: Request for Global Transaction ID: In the event that the Financial Identifier is generated internally by the system of the present invention, Global Transaction ID is generated that is linked uniquely to a merchant transaction and may include numbers, letters or other symbols recognized by the financial institution. Global Transaction ID may be generated using suitable mathematical formulae and/or an additional reference number such but not limited to as the transaction number, the amount and/or the termination date.

Step 130: Response Financial Identifier: In the event that step 120 was performed, the Financial Identifier is transmitted to the central transaction manager 50 by the financial institution. This financial identifier may include numbers, letters or other symbols recognized by the financial institution. Once received, the central transaction manager 50 relates the financial identifier or global transaction ID to a merchant transaction at which point it may be considered a Global Transaction ID.

Step 140: Response Global Transaction ID. The central transaction manager 50 sends the Global Transaction ID to the merchant 20, alone or together with transaction information useful for the merchant. The response may be for a specific transaction or for a list of transactions previously provided to the central transaction manager 50 by the merchant 20.

Step 150: Response (Global Transaction ID, Amount). The merchant 20, on his own or through central transaction manager 50, sends the Global Transaction ID to be funded at a financial institution as well as the amount to be paid. The merchant 20 may include additional information for the customer.

Step 160: Request to fund Global Transaction ID (Global Transaction ID, Amount). The customer 10 funds the Global Transaction ID at a financial institution 30 using a payment method of its preference. Since the Global Transaction ID is a financial institution's identifier, it can be funded directly without providing any additional transaction information, merchant information or specification of type of purchase.

Step 170: Response Global Transaction ID funded. The financial institution 30 notifies the central transaction manager 50 that funds have been accredited to the financial identifier recognized by the central transaction manager 50 as Global Transaction ID by associating that financial identifier with the merchant transaction information available at the central transaction manager 50 as per step 110 above.

Step 180: Send Transaction Paid (transaction ID). The central transaction manager 50 notifies the merchant 20 that the transaction has been paid according to the transaction information previously provided by the merchant 20 in step 110, typically after verifying that the amount funded and the date of funding corresponds to the specifications of the transaction.

Step 190: Send Merchandise. The merchant 30 conventionally provides the products and/or services ordered by the customer, following successful completion of the steps above.

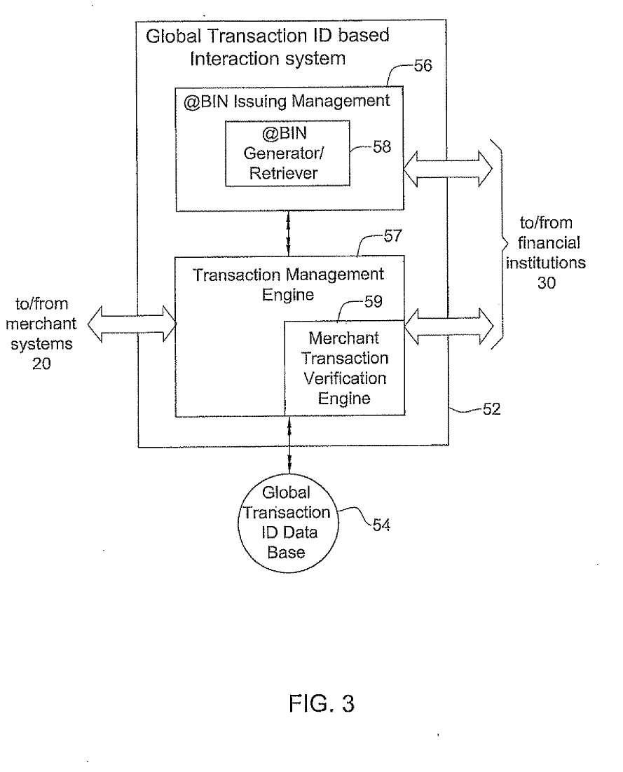

FIG. 3 is a simplified block diagram illustration of the central transaction manager 50 of FIG. 1 constructed and operative in accordance with an embodiment of the present invention and typically including central processor 52 which comprises a Global Transaction ID Issuing Management subsystem 56 and a Transaction Management Engine 57, and the Database 54 which may for example store, for each transaction, some or all of the information presented above in Table I.

The Global Transaction ID Issuing Management subsystem 56 generates and/or retrieves, e.g. from external sources, financial identifiers, through its Global Transaction ID Generator/Retriever 58, according to merchants' requests received from the Transaction Management Engine 57. A Global Transaction ID may comprise an individual financial identifier uniquely linked to a merchant transaction by the central transaction manager 50.

The Transaction Management Engine 57 receives the transactions' information from merchants 20, requests Global Transaction IDs from the Global Transaction ID Issuing Management subsystem 56 and Global Transaction ID funding notifications from external sources, and then manages, accordingly, the Global Transaction ID transactions statuses at Database 54. The Transaction Management Engine 57, among other activities, uses a Merchant Transaction Verification Engine to verify transaction information e.g. by reviewing termination dates of Global Transaction IDs and/or verifying Global Transaction ID funding notifications received against transactions' information available in the database 54.

Some or all of merchants' information, Global Transaction ID's statuses, transactions' history and/or transactions' reports are stored in the database 54 for retrieval by the Transaction Management Engine 57 as needed.

It is appreciated that the transaction management system shown and described herein has a wide variety of applications such as but not limited to the following:

### Example 1

Payment for a transaction is effected using a PIN-Debit card. A customer initiates a transaction at an Internet merchant. As a result, it receives a Global Transaction ID and the amount to be paid as well as the termination date of the transaction. The customer then physically approaches the nearest ATM and initiates a card-to-card transfer. When requested to enter the card number to receive the funds, it enters the Global Transaction ID received as well as the amount to be transferred according to the amount he received. The central transaction manager 50 receives a notification from the banking system maintaining the ATM, in its capacity as a financial institution 30, that a card with the number of the Global Transaction ID abovementioned has been funded. The central transaction manager 50 typically verifies the transaction information and confirms the funding has been performed according to the correct amount and before the termination date. The central transaction manager sends a payment confirmation to the merchant accordingly.

### Example 2

A merchant 20 requests 100 global transaction IDs for 10 dollar transactions each with no termination date. The merchant is promoting a subscription to a new service and sends these Global Transaction IDs to potential customers by email. The transaction management engine 57 receives, sporadically, notifications of funding for individual ones of the 100 Global Transaction IDs generated and sends notification of payment to the merchant 20 accordingly.

### Example 3

A customer 10 buys via SMS from a merchant 20. The customer 10 receives an SMS response from its merchant 20 including a Global Transaction ID for payment. The customer 10 may access its online bank account through a computer or through the mobile phone and perform a wire transfer to the Global Transaction ID, or it may call a phone banking system for performing such wire transfer.

### Example 4

A customer 10 may buy by catalog mail order, providing its buying information by phone and receiving a Global Transaction ID from the telemarketer. The customer 10 may fund this Global Transaction ID at the bank branch with cash.

### Example 5

### Multiple-Use Global Transaction ID

A non-profit organization allows its supporters to contribute any amount on any date. This organization may send Global Transaction IDs by mail to its supporters and these will fund the Global Transaction IDs as many times, and with whatever amount desired.

The system shown and described herein may be materialized in many other modes without affecting its nature and capacity. The examples abovementioned are descriptive but not restrictive.

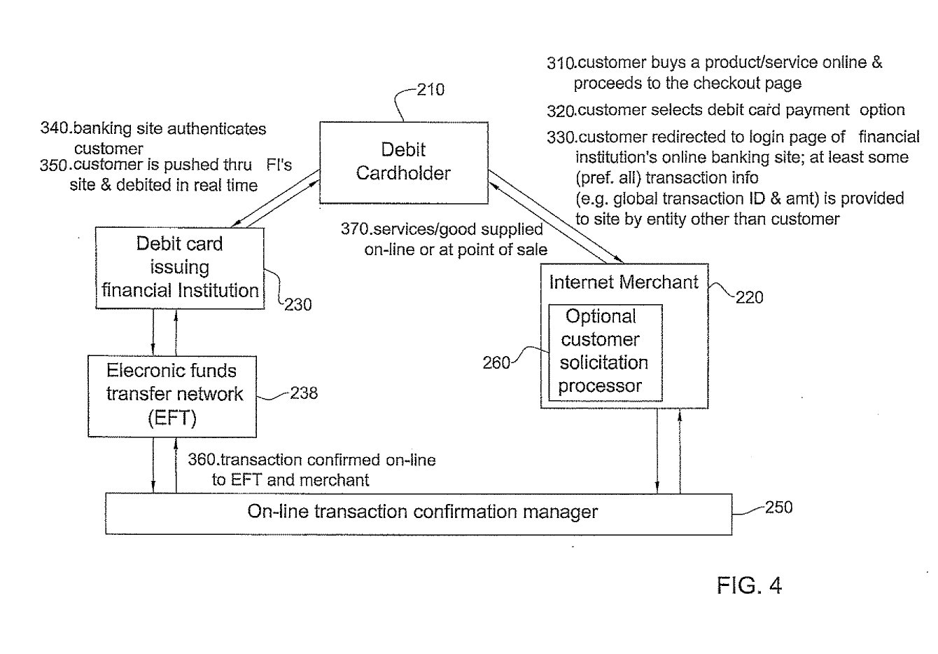

FIG. 4 is a transaction management system constructed and operative in accordance with a preferred embodiment of the present invention which operates on-line or in real time. Settlement vis a vis merchants is not necessarily on-line, however in the embodiment of FIG. 4, debiting of customers and confirmation thereof to merchants, occurs on-line e.g. in real time.

The system of FIG. 4 is preferably characterized by one, some or all of the following features:

a. The customer is debited in real time, e.g. by pushing a customer to select a debit card option and using a conventional A to A scheme to debit the customer's card, and confirmation of the customer's having been debited, although not necessarily the corresponding crediting of the relevant merchant's account, also occurs on-line.

b. The customer is pushed to his financial institution's login page e.g. by generating a database storing financial institutions' login pages' network locations during set-up and then, during operation: prompting the customer to input the identity of his financial institution e.g. by selection from a menu of financial institutions, looking up the network location of the login page of the FI identified by the customer in the . . . and responsively sending, to the customer's computer, a URL identifying the login page of the customer-identified financial institution.

c. After login, the customer is pushed through the financial institution's online banking site e.g. by providing suitable “routing information” to the site, e.g. in session HTML parameters “hidden” in a URL, routing the customer toward a transaction confirmation form.

d. The merchant or on-line transaction confirmation manager is operative to provide to the online banking site, e.g. in the form of hidden/session HTML parameters, at least some and preferably all characteristics of the transaction employed in order to identify the transaction in the foreground to the customer and in order to enable processing of the transaction in the background. For example, the merchant or on-line transaction confirmation manager may send the site a product caption, for display to the customer, a transaction amount (both for display to the customer e.g. within a payment form and for processing), and the transaction's global ID, for processing and optional display.

e. Debiting of the customer may result in crediting of the on-line transaction confirmation manager 250 which may maintain a multiplicity of electronic accounts for this purpose, each identified by an individual global transaction ID. Eventually, e.g. periodically, these accounts are settled vis a vis the corresponding merchants.

f. At least one individual merchant from among the second plurality of merchants includes a customer solicitation processor 260 operative to obtain a set of global transaction identifiers from the FI processor and to transmit the set of global transaction identifiers, to a set of at least potential customers, respectively. This enables a potential customer, if he/she is a customer of at least one of the financial institutions 230, to initiate an on-line transaction with the individual merchant 220 via the processor of on-line transaction confirmation manager 250 without previously initiating contact with the merchant. It is appreciated that the merchant may be a philanthropist, in which case the customer's transaction is considered as a contribution.

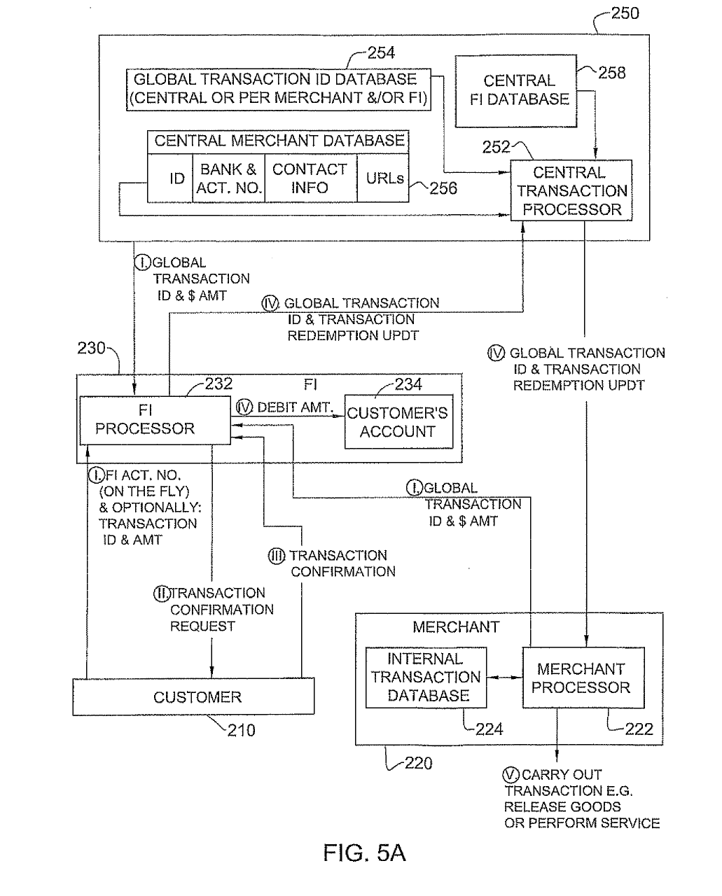

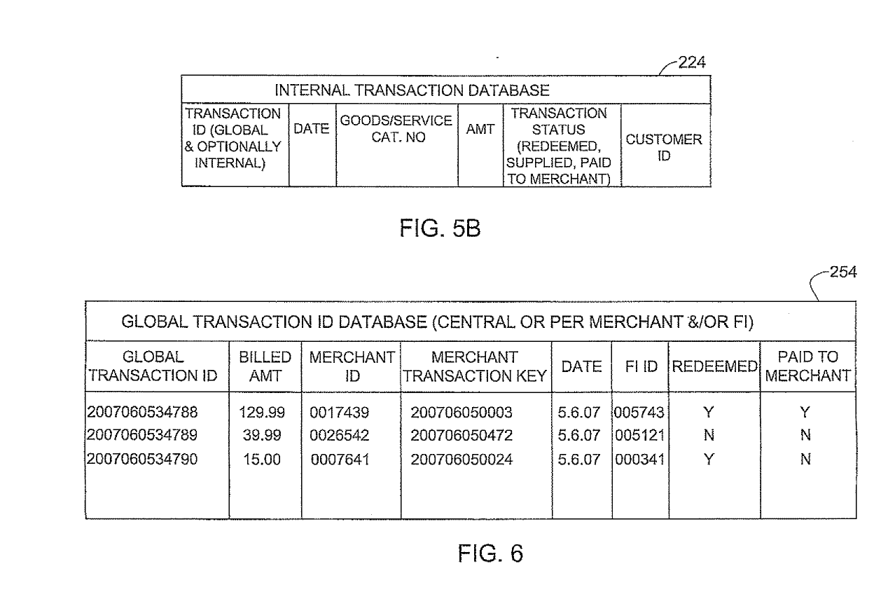

FIG. 5A is a simplified block diagram illustration of one possible implementation of the system of FIG. 4 in which Roman numerals are used to indicate one possible temporal ordering and identical Roman numerals are used to indicate operations which may occur generally simultaneously. As shown, the merchant 220 typically comprises a merchant processor 222 and an internal transaction database 224, one implementation of which is shown in detail in FIG. 5B Financial institution 230 typically comprises an FI processor 232 and a multiplicity of customer accounts 234 typically stored in a database. The transaction confirmation manager typically maintains one or more central databases such as a global transaction ID database 254, a merchant database 256 including an ID, account information, contact information, and information network location (e.g. URL) for each of a population of merchants, and a database 258 of participating financial institutions such as specific credit card companies and banks.

FIG. 6 is a table illustrating one possible implementation of the global transaction ID database 254 of FIG. 5A. It is appreciated that the uniqueness of the global transaction identifiers only becomes apparent within a suitable long period of time. Even if a long period of time has elapsed, a global transaction identifier used in the past for a transaction long defunct, can be re-used for another transaction.

It is appreciated that many computerized transaction management methods may be put into practice based on the embodiments of FIGS. 1-6, such as but not limited to the following:

Method I—Sale and Payment on-Line Over the Internet Using a Global Transaction ID

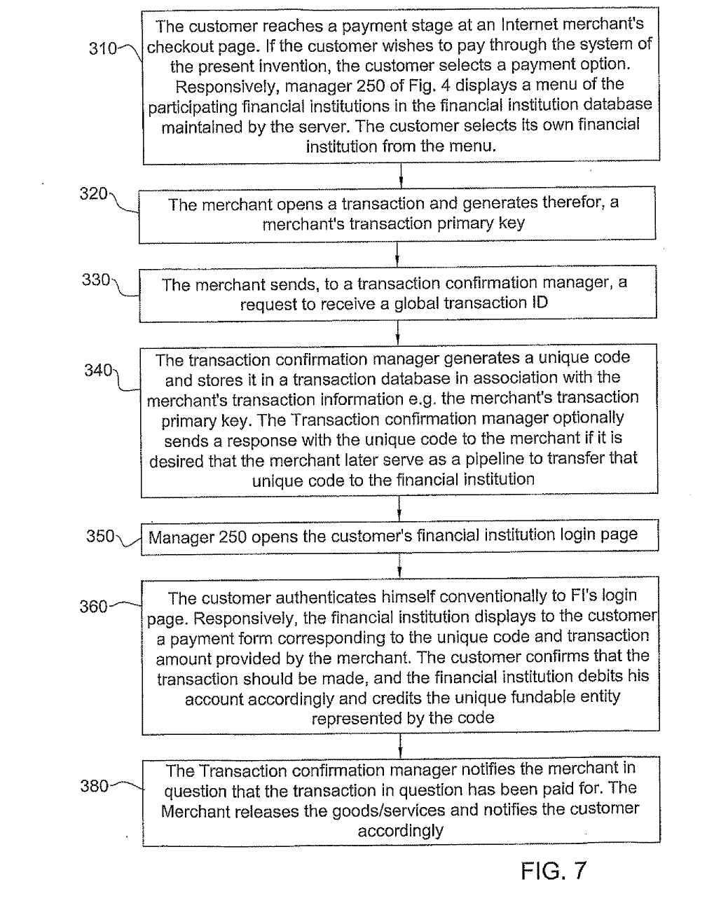

With reference to FIG. 7, it is seen that this method may comprise some or all of the following steps suitably ordered e.g. in the order shown:

Step 310: The customer reaches a payment stage at an Internet merchant's checkout page. If the customer wishes to pay through the system of the present invention, the customer selects a payment option which may, for example, be entitled “debit card”. Responsively, the system of the present invention e.g. manager 250 of FIG. 4, displays a menu of the participating financial institutions in the financial institution database maintained by the server, such as various national or regional banks or debit card networks including EFT networks. The customer selects his own financial institution from the menu.

Step 320: The merchant opens a transaction and generates therefor, a merchant's transaction primary key which is used internally by the merchant to identify his transactions uniquely. The key may, for example, comprise a serial number and hence is only unique to the merchant himself and not between merchants. For example, each merchant may assign an ID number such as a serial number to each transaction on a particular day and the merchant's transaction primary key for a given transaction may be a concatenation of the date, and the serial number of the transaction in question on that particular date.

Step 330: The merchant sends, to a transaction confirmation manager, a request to receive a global transaction ID. The merchant's request includes at least the following data: merchant's transaction primary key and transaction amount.

Step 340: The transaction confirmation manager generates a unique code (e.g. alphanumeric code) and stores it in a transaction database in association with the merchant's transaction information e.g. the merchant's transaction primary key. The code is typically unique in the sense that it uniquely defines a particular transaction between a particular merchant and a particular customer as well as a particular fundable entity within a financial institution or financial network. The transaction confirmation manager typically sends a response with the unique code to the merchant if it is desired that the merchant will later serve as a pipeline to transfer that unique code to the financial institution.

Step 350: The system of the present invention, e.g. manager 250, then directs the customer to an online presence, such as a website, of the financial institution selected by the customer in step 310. For example, the manager 250 may open the customer's financial institution login page. As part of the URL, the merchant typically submits the unique code and the transaction amount to the financial institution.

Step 360: The customer then authenticates himself to his financial institution using the conventional authentication procedure provided by the FI's login page. Responsively, the financial institution displays to the customer a payment form corresponding to the unique code and transaction amount provided by the merchant. The customer confirms that the transaction should he made, and the financial institution debits his account accordingly and credits the unique fundable entity represented by the code, optionally after first validating the code and amount with the transaction confirmation manager (i.e. the FI queries the server to confirm that the code in question pertains to a transaction whose value is the amount in question). Typically, the financial transaction is effected using the A2A mechanism. The redemption confirmation sent by the FI to the server may optionally include information identifying the redeemed payment form such as at least the unique code and typically additional information such as the amount paid. Typically, the server is informed about a transfer of funds made to the unique code representing a fundable entity and confirms that the fundable entity has been funded with the correct amount corresponding to the transaction represented by the unique code.

Step 380: The Transaction confirmation manager notifies the merchant in question that the transaction in question has been paid for. Typically this notification occurs when the payment form associated with the specific transaction primary key has been redeemed successfully. Responsively, the Merchant typically releases the goods/services and notifies the customer accordingly.

There are various variations, such as sale over the Internet as above, but with payment offline or via mobile phone instead of over the Internet as above. Or, payment may be over Internet as above, however the sale is effected by telephone instead of via Internet. Finally, sales may be effected by telephone and payment may be effected by mobile telephone such that there is no Internet access involved at all. A billing company may be involved. Certain of these variations are now described, merely by way of example.

### Method II—Sale Over the Internet and Payment Offline Using a Global Transaction ID

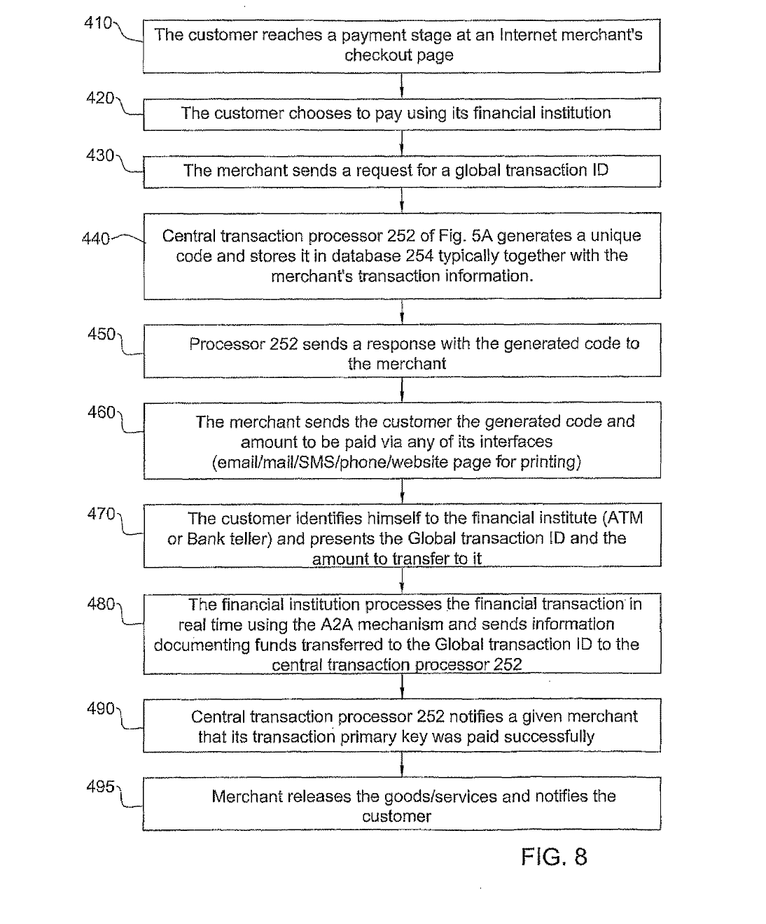

With reference to FIG. 8, it is seen that this method may comprise some or all of the following steps suitably ordered e.g. in the order shown:

Step 410: The customer reaches a payment stage at an Internet merchant's checkout page.

Step 420: The customer chooses to pay using his financial institution. The available financial institutions' list is maintained e.g. as a central FI database 258 (FIG. 5A) and updated as needed.

Step 430: The merchant sends a request for a global transaction ID. The merchant's request includes at least the following data: merchant's transaction primary key and transaction amount. The merchant's transaction primary key could be the merchant's transaction ID only or a combination of different data fields that allow the unique identification of the purchasing transaction for a given merchant.

Step 440: Central transaction processor 252 of FIG. 5A generates a unique code and stores it in database 254 typically together with the merchant's transaction information.

Step 450: Processor 252 sends a response with the generated code to the merchant.

Step 460: The merchant sends the customer the generated code and amount to be paid via any of its interfaces (email/mail/SMS/phone/website page for printing).

Step 470: The customer identifies himself to the financial institute (ATM or Bank teller) and presents the Global transaction ID and the amount to transfer to it.

Step 480: The financial institution process the financial transaction in real time using the A2A mechanism, sends information documenting funds transferred to the Global transaction ID to the central transaction processor 252. The information sent may optionally include at least the Global transaction ID and the amount paid.

Step 490: Central transaction processor 252 notifies a given merchant that his transaction primary key was paid successfully.

Step 495: Merchant releases the goods/services and notifies the customer.

### Method III—Sale Over the Internet and Payment, Using a Global Transaction ID, by Mobile Phone

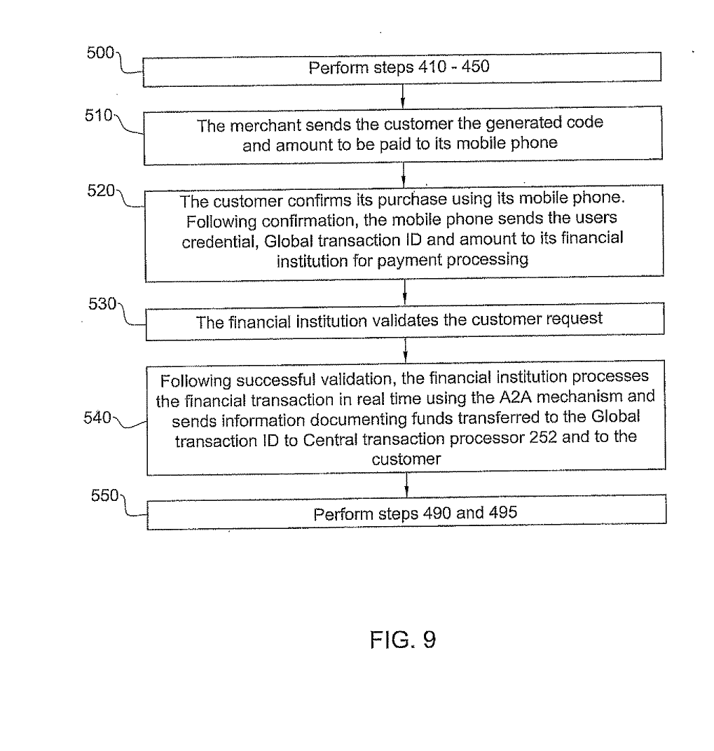

With reference to FIG. 9, it is seen that this method may comprise some or all of the following steps suitably ordered e.g. in the order shown. This method may be like method II, except that steps 460 to 480 are replaced by the following steps:

Step 510: The merchant sends the customer the generated code and amount to be paid to its mobile phone.

Step 520: The customer confirms his purchase using a mobile phone. Following confirmation, the mobile phone sends the user's credentials, Global transaction ID and amount to its financial institution for payment processing.

Step 530: The financial institution validates the customer request.

Step 540: Following successful validation, the financial institution processes the financial transaction in real time using the A2A mechanism, sends information documenting funds transferred to the Global transaction ID to Central transaction processor 252 and to the customer. The information sent to Central transaction processor 252 optionally includes at least the Global transaction ID and the amount paid.

### Method IV—Sale Online/Offline and Payment, Using a Global Transaction ID, by Mobile Phone

Like method III except that step 410 is replaced by a step in which the customer makes his purchase using his mobile telephone.

### Method V—Sale Over MOTO (Mail Order/Telephone Order) and Payment, Using a Global Transaction ID, by Internet

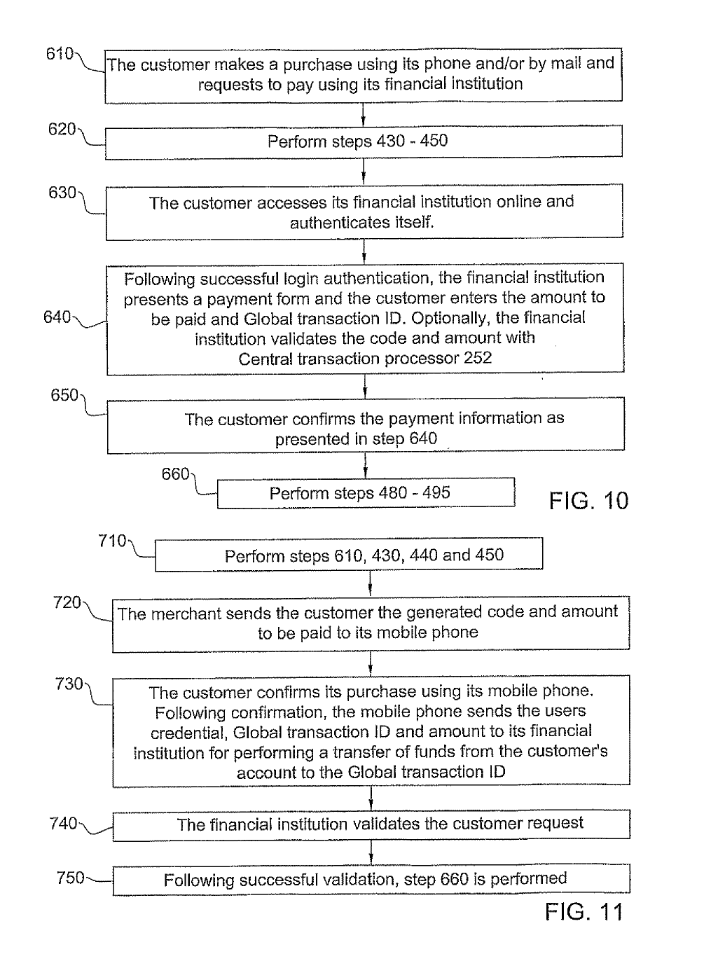

With reference to FIG. 10, it is seen that this method may comprise some or all of the following steps suitably ordered e.g. in the order shown:

Step 610: The customer makes a purchase using his phone/by mail and requests to pay using his financial institution.

Step 620: Perform steps 430-450 above.

Step 630: The customer accesses his financial institution online and authenticates himself.

Step 640: Following successful login authentication, the financial institution presents a payment form and the customer enters the amount to be paid and Global transaction ID. Optionally, the financial institution validates the code and amount with Central transaction processor 252.

Step 650: The customer confirms the payment information as presented in step 640.

Step 660: Perform steps 480-495 above.

### Method VI—Sale Over MOTO (Mail Order/Telephone Order) and Payment, Using a Global Transaction ID, Offline

Like Method V, except that steps 630, 640 and 650 are omitted. Instead, the customer identifies himself to the financial institute (ATM or Bank teller) and presents the Global transaction ID and the amount to pay.

### Method VII—Using a Global Transaction ID for Sale Over Phone and Mobile Phone

With reference to FIG. 11, it is seen that this method may comprise some or all of the following steps suitably ordered e.g. in the order shown:

Step 710: Perform steps 610, 430, 440 and 450.

Step 720: The merchant sends the customer the generated code and amount to be paid to his mobile phone.

Step 730: The customer confirms his purchase using his mobile phone. Following confirmation, the mobile phone sends the user's credentials, Global transaction ID and amount to his financial institution for performing a transfer of funds from the customers account to the Global transaction ID.

Step 740: The financial institution validates the customer request.

Step 750: Following successful validation, step 660 is performed.

### Method VIII—Management of Transactions Occurring Via Billing Companies, Using a Global Transaction ID

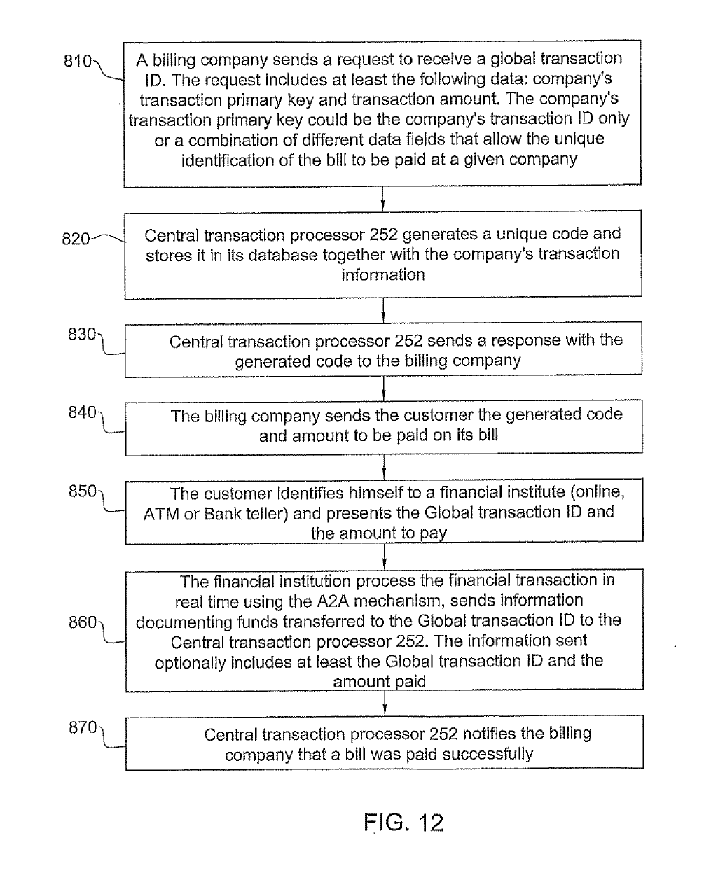

With reference to FIG. 12, it is seen that this method may comprise some or all of the following steps suitably ordered e.g. in the order shown:

Step 810: A billing company sends a request to receive a global transaction ID. The request includes at least the following data: company's transaction primary key and transaction amount. The company's transaction primary key could be the company's transaction ID only or a combination of different data fields that allow the unique identification of the bill to be paid at a given company.

Step 820: Central transaction processor 252 generates a unique code and stores it in its database together with the company's transaction information.

Step 830: Central transaction processor 252 sends a response with the generated code to the billing company.

Step 840: The billing company sends the customer the generated code and amount to be paid on his bill.

Step 850: The customer identifies himself to a financial institute (online, ATM or Bank teller) and presents the Global transaction ID and the amount to pay.

Step 860: The financial institution processes the financial transaction in real time using the A2A mechanism, sends information documenting funds transferred to the Global transaction ID to the Central transaction processor 252. The information sent optionally includes at least the Global transaction ID and the amount paid.

Step 870: Central transaction processor 252 notifies the billing company that a bill was paid successfully.

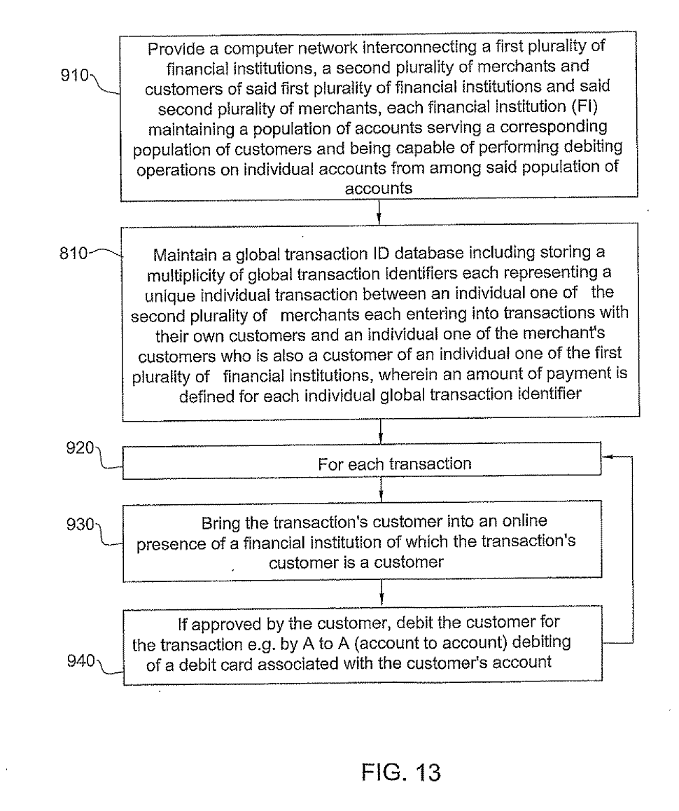

Reference is now made to FIG. 13 which is a simplified flowchart illustration of a method for interaction, via a computer network, between a first plurality of financial institutions, a second plurality of merchants and customers of the first plurality of financial institutions and the second plurality of merchants, all interconnected by the computer network, the method being constructed and operative in accordance with a preferred embodiment of the present invention.

It is appreciated that the term “financial institution” is intended to include debit networks such as EFT networks and more generally, any organization dealing with remittance of funds or electronic messages representing such. The term “financial institution” is also intended to include a set of one or more such organizations which cooperate with one another in accordance with certain embodiments of the present invention. For example, a first organization having the above functionality may communicate with a customer and a second such organization may receive the message from the first organization and transmit it to a central transaction processor. For example, the customer may authenticate himself with his own online banking presence, thereby crediting a Global transaction ID representing a debit card at an EFT network. The EFT network is notified of the credit and responsively sends notification to the number owner (the entity which allocates global transaction IDs), which may be the central transaction processor, as to the credit of funds.

Particular advantages of certain of the embodiments shown and described herein may include one, some or all of the following:

(a) a third party can do nothing with the information, such as the global transaction identifier, used to complete a transaction. Typically, the global transaction identifier, as information, is worthless for any party and its sole and only utility is to represent, on the one hand, a corresponding merchant-customer transaction and on the other hand, a financial number which is accepting a corresponding purchase amount.

(b) Financial Institutions typically do not send back the Global transaction ID and the amount for confirmation of payment. Instead, they typically merely inform that funds have been transferred to the Global transaction ID as with any account or payment card that has been funded. This information may be obtained by server 50 of FIG. 1 by querying the FI system about the status of the FI accounts identified with particular Global transaction IDs.

(c) The FI processor shown and described herein is typically operative to debit a customer's account and to directly credit the global transaction identifier, in its capacity as a fundable entity, accordingly. In the direct crediting process, the global transaction ID, like a conventional bank account number, is capable of accepting a purchase sum from the customer's account like any other bank account, and therefore the purchase sum may be transferred from the customer's account to the global transaction identifier rather than to any intermediary.

It is appreciated that any suitable information network, such as the World Wide Web or any telephone network, and any suitable information transfer technologies and protocols may be used to transmit information between the components of the systems shown and described herein. According to one embodiment of the invention, the system may comprise one or more computers or other programmable devices, preferably equipped with input devices such as a keyboard and mouse operative to allow users to provide input to the system as described herein, and output devices such as a printer or interface with communication network servers such as Internet servers or with communication devices such as a cellular telephone.

Each computer may be programmed in accordance with some or all of the apparatus, methods, features and functionalities shown and described herein. Alternatively or in addition, the apparatus of the present invention may comprise a memory which is readable by a machine and which contains, stores or otherwise embodies a program of instructions which, when executed by the machine, comprises an implementation of some or all of the apparatus, methods, features and functionalities shown and described herein. Alternatively or in addition, the apparatus of the present invention may comprise a computer program implementing some or all of the apparatus, methods, features and functionalities shown and described herein and being readable by a computer for performing some or all of the methods of, and/or implementing some or all of the systems of, embodiments of the invention as described herein.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Features of the present invention which are described in the context of separate embodiments may also be provided in combination in a single embodiment. Conversely, features of the invention which are described for brevity in the context of a single embodiment may be provided separately or in any suitable subcombination.

1. A system for interaction between a first plurality of financial institutions, a second plurality of merchants and customers of the first plurality of financial institutions and of the second plurality of merchants, each financial institution (FI) maintaining a population of accounts serving a corresponding population of customers, each financial institution being capable of performing debiting operations on individual accounts from among the corresponding population of accounts, the system comprising:
a global transaction ID database for storing a multiplicity of global transaction identifiers each representing a unique individual transaction between an individual one of the second plurality of merchants each entering into transactions with their own customers and an individual one of the individual merchant's customers who is also a customer of an individual one of the first plurality of financial institutions, wherein an amount of payment is defined for each individual global transaction identifier; and
for each FI from among the first plurality of financial institutions, an FI processor which is operative to receive:
an on-the-fly indication of an individual one of the FI's accounts corresponding to an individual one of the FI's customers,
a global transaction identifier, and
a corresponding amount of payment to be debited from that individual account upon customer confirmation;
to transmit to said individual one of the financial institution's customers, on-the-fly, a request to confirm debiting of the corresponding amount of payment from the customer's account for the transaction corresponding to the global transaction identifier;
to accept from the customer a responsive confirmation; and
to debit the customer's account accordingly.

2. A system according to claim 1 and also comprising, for each of the second plurality of merchants, a merchant's internal transaction ID database for storing a population of internal transaction identifiers each representing, to a corresponding individual merchant, an individual transaction between the individual merchant and an individual one of the individual merchant's customers, at least one internal transaction identifier being associated with a global transaction identifier.

3. A system according to claim 1 wherein said transaction comprises a service transaction.

4. A system according to claim 1 wherein said transaction comprises a goods transaction.

5. A system according to claim 1 wherein said individual one of the second plurality of merchants receives on-the-fly confirmation of the debiting of the customer's account.

6. A system according to claim 1 wherein a copy of said global transaction ID database is maintained in each financial institution.

7. A system according to claim 1 wherein a copy of said global transaction ID database is maintained on the premises of each merchant.

8. A system according to claim 2 and also comprising a central transaction processor operative to update said merchant's internal transaction ID database if informed by the FI processor that the transaction corresponding to the global transaction identifier has been redeemed.

9. A system according to claim 1 wherein a customer of at least an individual one of the first plurality of financial institutions is operative to provide to said individual financial institution's FI processor an on-the-fly indication of at least some of the following information: an individual one of the FI's accounts, a global transaction identifier and a corresponding amount of payment to be debited from that account.

10. A system according to claim 2 and also comprising, for each merchant, a merchant processor operative, responsive to an update to the merchant's internal transaction ID database indicating that a transaction has been redeemed, to carry out the transaction.

11. A system according to claim 8 wherein said central transaction processor is operative to provide to the FI processor an on-the-fly indication of at least some of the following information: an individual one of the FI's accounts, a global transaction identifier and a corresponding amount of payment to be debited from that account upon customer confirmation of the transaction.

12. A system according to claim 8 wherein said FI processor is operative to update said merchant's internal transaction ID database by informing said central interaction processor that the transaction corresponding to the global transaction identifier has been redeemed.

13. A system according to claim 5 wherein said individual one of the second plurality of merchants provides at least one of goods and services on-line, responsive to said on-the-fly confirmation.

14. A system according to claim 1 and also comprising a central financial institution database storing identifying information pertaining to each of the first plurality of financial institutions.

15. A system according to claim 1 and also comprising a central merchant database storing identifying information pertaining to each of the second plurality of merchants.

16. A system according to claim 1 and also comprising apparatus for bringing a customer into an online presence of an individual one of said first plurality of financial institutions, within which said request to confirm debiting is transmitted to said customer, on-the-fly.

17. A system according to claim 1 wherein the amount credited to the global transaction identifier for each transaction is then transferred to an account belonging to the merchant corresponding to the transaction, off-line.

18. A method for interaction, via a computer network, between a first plurality of financial institutions, a second plurality of merchants and customers of said first plurality of financial institutions and said second plurality of merchants, all interconnected by the computer network, each financial institution (FI) maintaining a population of accounts serving a corresponding population of customers and being capable of performing debiting operations on individual accounts from among said population of accounts, the method comprising:
maintaining a global transaction ID database including storing a multiplicity of global transaction identifiers each representing a unique individual transaction between an individual one of the second plurality of merchants each entering into transactions with their own customers and an individual one of the merchant's customers who is also a customer of an individual one of the first plurality of financial institutions, wherein an amount of payment is defined for each individual global transaction identifier; and
for each transaction, bringing the transaction's customer into an online presence of a financial institution of which the transaction's customer is a customer.

19. A method according to claim 18 and also comprising A to A (account to account) debiting of a debit card associated with the customer's account.

20. A system according to claim 10 wherein said merchant processor is operative to provide to the FI processor an on-the-fly indication of at least some of the following information; a global transaction identifier and a corresponding amount of payment to be debited from that account upon customer confirmation of the transaction.

21. A system according to claim 2 wherein said FI processor is also operative to update the merchant's internal transaction ID database to indicate that the transaction corresponding to the global transaction identifier has been redeemed.

22. A system according to claim 2 wherein at least one internal transaction identifier equals the global transaction identifier associated therewith.

23. A system according to claim 1 wherein at least one individual merchant from among the second plurality of merchants includes a customer solicitation processor operative to obtain a set of global transaction identifiers from the FI processor and to transmit the set of global transaction identifiers to a set of at least potential customers, respectively, thereby to enable a potential customer, if it is a customer of at least one of the first plurality of financial institutions, to initiate an on-line transaction with the individual merchant via the FI processor without previously initiating contact with the merchant.

24. A system for processing payment transactions between merchants and customers, via financial institutions, the system comprising:
apparatus for generating global transaction identifiers each of which is recognized by the merchants as a transaction ID and by the financial institutions as a fundable entity.

25. A system for interaction between a first plurality of financial institutions, a second plurality of merchants and customers of the first plurality of financial institutions and said second plurality of merchants, each financial institution (FI) maintaining a population of accounts serving a corresponding population of customers, each financial institution being capable of performing debiting operations on individual accounts from among said population of accounts, the system comprising:
a global transaction ID database for storing a multiplicity of global transaction identifiers each representing a unique individual transaction between an individual one of the second plurality of merchants each entering into transactions with their own customers and an individual one of the merchant's customers who is also a customer of an individual one of the first plurality of financial institutions, wherein an amount of payment is defined for each individual global transaction identifier, and wherein each individual global transaction identifier is identified by financial institutions as a fundable entity; and
for each of the first plurality of financial institutions, an FI processor operative:
to receive:
an on-the-fly indication of an individual one of the FI's accounts corresponding to an individual one of the FI's customers,
a global transaction identifier, and
a corresponding amount of payment to be debited from that account upon customer confirmation;
to debit the customer's account accordingly; and
to directly credit the global transaction identifier in its capacity as a fundable entity.

26. A system according to claim 1 and also comprising at least one financial institution storing, for each individual debiting operation, documentation justifying said individual debiting operation.

27. A system according to claim 1 wherein each individual global transaction identifier is recognized by the financial institutions as a fundable entity.

28. A system according to claim 1 and also comprising apparatus for pushing a customer through an online presence of an individual one of said first plurality of financial institutions, including presenting the customer with a payment form containing data for the transaction corresponding to the global transaction identifier.

29. A method according to claim 18 and also comprising, for each individual transaction, pushing the transaction's customer through the online presence of the customer's financial institution including presenting the customer with a payment form, within said online presence, containing data for said individual transaction.

30. A system according to claim 16 wherein said on-line presence comprises a website.

31. A method according to claim 18 wherein said on-line presence comprises a website.
